(19) United States
(12) Patent Application Publication
(10) Pub. No.: US 2024/0161165 A1
(43) Pub. Date: May 16, 2024

(54) CROSS-DOMAIN RECOMMENDATION VIA CONTRASTIVE LEARNING OF USER BEHAVIORS IN ATTENTIVE SEQUENCE MODELS

(71) Applicant: ETSY, Inc., Brooklyn, NY (US)

(72) Inventors: Zhabiz Gharibshah, Brooklyn, NY (US); Murium Iqbal, Cottonwood Heights, UT (US); Gaurav Anand, New York, NY (US); Alireza Sahami Shirazi, San Jose, CA (US)

(73) Assignee: ETSY, Inc., Brooklyn, NY (US)

(21) Appl. No.: 18/387,081

(22) Filed: Nov. 6, 2023

Related U.S. Application Data
(60) Provisional application No. 63/423,244, filed on Nov. 7, 2022.

(51) Int. Cl. G06Q 30/0601; G06N 3/0455; G06N 3/0895

(52) U.S. Cl. CPC G06Q 30/0631; G06N 3/0455; G06N 3/0895

(57) ABSTRACT

The technology involves a personalized recommender system that can be used with an e-commerce platform. It employs a contrastive learning based cross-domain recommendation approach. The approach balances the learning of user behaviors within each domain, as well as user behaviors across multiple domains. To achieve robust user representations and to improve knowledge transfer between the source and target domains, multi-task intra-domain contrastive regularizations may be employed along with multiple branches of sequential attentive encoders in a model for cross-domain sequential recommendation. Different data augmentation approaches can be used to generate augmented data for contrastive learning. For instance, different data augmentation methods may be combined with recommendation optimization in a multi-task learning paradigm. An optimized sequence representation may be fine-tuned in a next-value prediction task for recommendation in a target domain.

### CROSS-REFERENCE TO RELATED APPLICATIONS

This application claims the benefit of the filing date and priority to U.S. Provisional Patent Application No. 63/423,244, filed Nov. 7, 2022, the entire disclosure of which is incorporated herein by reference.

### BACKGROUND

Sequential modeling-based recommendation systems have been widely adopted in the e-commerce industry to capture user intent. Due to large numbers of customers and items, user sequences are often sparse and noisy, and therefore hard to actually predict users' genuine interests. Cross-domain recommendation has therefore been introduced to leverage data from other domains to overcome sparsity and improve the quality of recommendations in the target domain. Nevertheless, existing cross-domain sequential recommendation models use observed user interactions for modeling. They heavily rely on modeling users whose behaviors overlap between domains, and may often fail if there are very few users whose behaviors cross two domains.

### SUMMARY

Aspects of the technology involve user representation learning for sequential recommendation tasks. A contrastive self-supervised learning method is provided in the cross-domain scenarios. Different data augmentation approaches can be used to generate augmented data for contrastive learning when dealing with tabular data. As there may be overlapping or non-overlapped users for cross-domain recommendation, different data augmentation methods may be combined with recommendation optimization in a multi-task learning paradigm. An optimized sequence representation may be fine-tuned in a next-value prediction task for recommendation in a target domain. Experiments on real-world datasets show that this approach is able to outperform certain state of the art baseline methods.

The technology is particularly beneficial for e-commerce platforms, as models trained as discussed herein are able during inference to provide targeted predictions (e.g., for goods such as jewelry, clothing, books, music, movies, etc.) to customers of the platforms. The technology addresses the issue of data used in e-commerce platform containing different types of biases as well as a variety of flaws. Due to the nature of how users interact with websites, noise may be included in their clicks. Such issues can be minimized by introducing augmented sequences for positive samples and employing a contrastive loss function to drive an original set of user interaction sequences to their augmented versions together in an embedding space.

In one scenario, the system can create faux overlapped users in order to train the model. This can be done by taking users who have similar histories in one domain and assuming their history in the other domain is the same. For instance, assume user A is overlapped, having history in both source and target (auxiliary) domains, while user B only has history in the source domain. It may be determined that User B has a history in the source domain that correlates with User A's history. By way of example, B's history may be almost the same as user A (clicked on mostly the same listings, such as at least 65%-85% of the same listings or more), then it can be presumed that user A's history in the target (auxiliary) domain is representative for user B and thus create a faux “overlapped” user by using user B's history in the source domain but user A's history in the target (auxiliary) domain.

According to one aspect of the technology, a computer-implemented method for training a model for cross-domain recommendations is provided, in which the method comprises: obtaining a first set of user interaction sequences associated with a source domain, the source domain being associated with a first category of items and a first group of users; obtaining a second set of user interaction sequences associated with a target domain, the target domain being associated with a second category of items and a second group of users, the second category being different from the first category, and one or more users of the second group overlapping with one or more of the users of the first group; performing self-supervised learning with a neural network in an embedding space to learn representations of the first and second sets of user interaction sequences, including embedding the user interaction sequences associated with the source domain and the user interaction sequences associated with the target domain in parallel, in which an encoder associated with the source domain and an encoder associated with the target domain share weights; applying an adversarial learning component to the encoders associated with the source and target domains, the adversarial learning component including a domain discriminator that is configured to classify a particular domain according to a given user interaction sequence; performing contrastive learning on outputs of the encoders, including (i) creating a set of augmented user interaction sequences from the first and second sets of user interaction sequences, and (ii) applying a contrastive loss function to drive the set of augmented user interaction sequences toward one or more of the user interaction sequences of the first and second sets in the embedding space; and training the model according to cross domain recommendations for user interaction sequences that are associated with one or more of the overlapping users, the trained model being configured to predict a given category of items to be selected by a given user.

The method may further comprise: receiving, by a processing device, user input regarding an item; identifying, by the processing device according to the trained model, one or more items of the given category of items; and causing, by the processing device, the one or more identified items to be presented to the given user. Alternatively or additionally to any of the above, the method may further comprise reordering at least one of the first set of user interaction sequences or the second set of user interaction sequences. Here, the reordering may comprise: generating a binary mask vector of either the first set of user interaction sequences or the second set of user interaction sequences; and applying a random shuffling to reorder one or more non-zero values in the binary vector.

Alternatively or additionally to any of the above, the method may further comprise creating a nominal overlapping user based upon a first user that only has interaction sequences in the source domain and a second user that has interaction sequences in both the source domain and the target domain. Here, the second user's interaction sequences in the source domain may correlate with the first user's interaction sequences in the source domain.

Alternatively or additionally to any of the above, embedding the user interaction sequences associated with the source domain and the user interaction sequences associated with the target domain in parallel may comprise embedding into a twin transformer encoder layer of an encoder component of the neural network. Alternatively or additionally to any of the above, the method may include the domain discriminator performing binary classification according to a user latent representation. Here, the binary classification may produce a unified user behavior sequence embedding vector.

According to another aspect of the technology, a method is provided that comprises: receiving, by a processing device of an e-commerce website, user input; identifying, by the processing device according to the model trained in any of the manners described above, one or more items of interest; generating information about the one or more items of interest; and causing the generated information to be presented to a selected user. The first category of items and the second category of items used to train the model may be, e.g., goods offered by the e-commerce website. Here, the method includes causing the generated information to be presented to the selected user includes generating information about selected goods from a category of items promoted by the e-commerce website. Alternatively or additionally, prior user interaction sequences by the selected user may only associated with one of the source domain or the target domain.

According to a further aspect of the technology, a computer system is configured to train a model for cross-domain recommendations. The computer system comprises: memory configured to store input source audio comprising one or more longform speech documents that are at least a minute in length; and one or more processors operatively coupled to the memory, the one or more processors being configured to implement a neural network that: obtains a first set of user interaction sequences associated with a source domain, the source domain being associated with a first category of items and a first group of users; obtains a second set of user interaction sequences associated with a target domain, the target domain being associated with a second category of items and a second group of users, the second category being different from the first category, and one or more users of the second group overlapping with one or more of the users of the first group; performs self-supervised learning with a neural network in an embedding space to learn representations of the first and second sets of user interaction sequences, including embedding the user interaction sequences associated with the source domain and the user interaction sequences associated with the target domain, in which an encoder associated with the source domain and an encoder associated with the target domain share weights; applies an adversarial learning component to the encoders associated with the source and target domains, the adversarial learning component including a domain discriminator that is configured to classify a particular domain according to a given user interaction sequence; performs contrastive learning on outputs of the encoders, including (i) creating a set of augmented user interaction sequences from the first and second sets of user interaction sequences, and (ii) applying a contrastive loss function to drive the set of augmented user interaction sequences toward one or more of the user interaction sequences of the first and second sets in the embedding space; and trains the model according to cross domain recommendations for user interaction sequences that are associated with one or more of the overlapping users, the trained model being configured to predict a given category of items to be selected by a given user.

The neural network may have a transformer architecture. Moreover, the encoders may be attention-based encoders. Alternatively or additionally to any of the above, the computer system may be further configured to: receive user input regarding an item; identify, according to the trained model, one or more items of the given category of items; and cause the one or more identified items to be presented to the given user. Alternatively or additionally to any of the above, embedding the user interaction sequences associated with the source domain and the user interaction sequences associated with the target domain in parallel may comprise embedding into a twin transformer encoder layer of an encoder component of the neural network. Alternatively or additionally to any of the above, the domain discriminator may be configured to perform binary classification according to a user latent representation. Here, the binary classification may produce a unified user behavior sequence embedding vector. Alternatively or additionally to any of the above, the domain discriminator may include a fully connected network.

### BRIEF DESCRIPTION OF THE DRAWINGS

FIGS. 1A-C illustrates an example of unsupervised training with augmentation and contrastive optimization in accordance with aspects of the technology.

FIG. 2 is an example transformer-type neural network architecture that may be employed with aspects of the technology.

FIG. 3 presents a table of statistics of datasets used for testing in accordance with aspects of the technology.

FIG. 4 presents a table comparing a cross-domain recommendation approach in accordance with aspects of the technology against other approaches.

FIG. 5 presents a table of results for an ablation study according to aspects of the technology.

FIGS. 6A-B present charts showing the impact of different sequence lengths on model performance, in accordance with aspects of the technology.

FIGS. 7A-B illustrate an example computer system that may be employed with aspects of the technology.

FIG. 8 illustrates a flow diagram of an example method in accordance with aspects of the technology.

### DETAILED DESCRIPTION

### Overview

Personalized recommendation systems are very beneficial in e-commerce platforms, as they can be used assist users in discovering relevant topics and items. Sequence modeling approaches are one way to implement personalized recommendations. The common property of user interactions in web-based applications is that there are temporal dependencies in user interactions. Capturing those dependencies can help the system obtain a better understanding of user interests and intentions. Certain systems may leverage the sequences of user historical interactions in one or more domains to capture the evolving dynamics of user preferences in next item prediction tasks.

However, sequential recommendation approaches deal with a sparsity issue and an uncertainty problem in user interactions logs. Users may have partial sparse interactions in one domain of items, which can make the performance of recommendations biased to observed interactions. A weakness of sequential user representation learning models is that they typically rely primarily on log data as definite sequences of user interaction, with all observed sequences considered positive samples and any non-visited sequence of user interactions considered negative samples. Such models lack a mechanism for dealing with variations in user interactions, which can be seen in positive samples.

The technology presented herein avoids such issues, for instance by employing a contrastive learning based cross-domain recommendation approach. It balances the learning of user behaviors within each domain, as well as user behaviors across multiple domains. To achieve robust user representations and to improve knowledge transfer between the source and target domains, multi-task intra-domain contrastive regularizations may be employed along with three branches of sequential attentive encoders in a model for cross-domain sequential recommendation. Experiments demonstrate that this approach is able to capture next user interests and provide considerable performance gain in datasets from two e-commerce platforms especially for domains with very sparse, e.g., less than 5%, overlapping users.

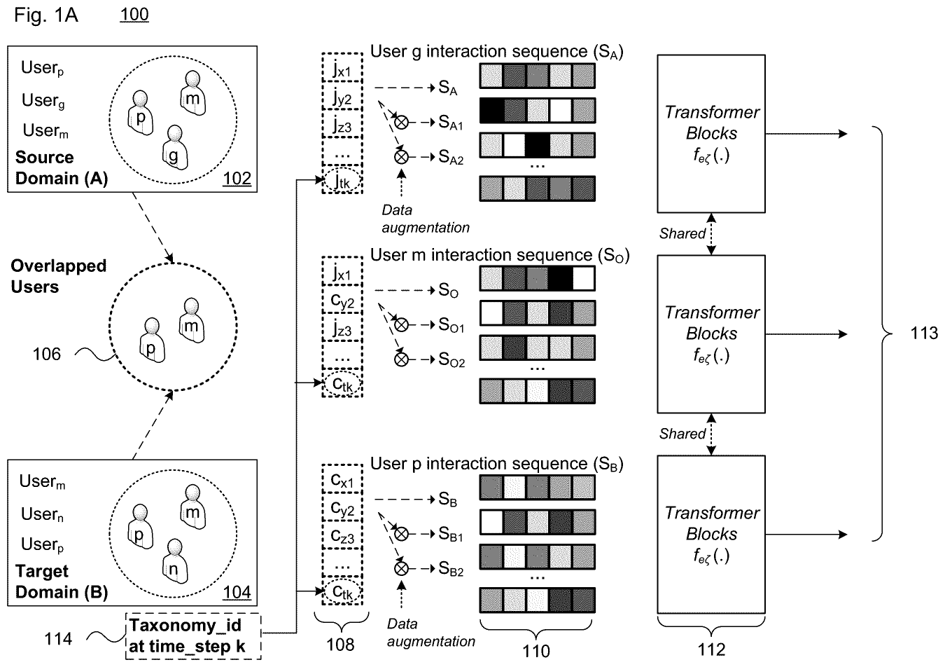

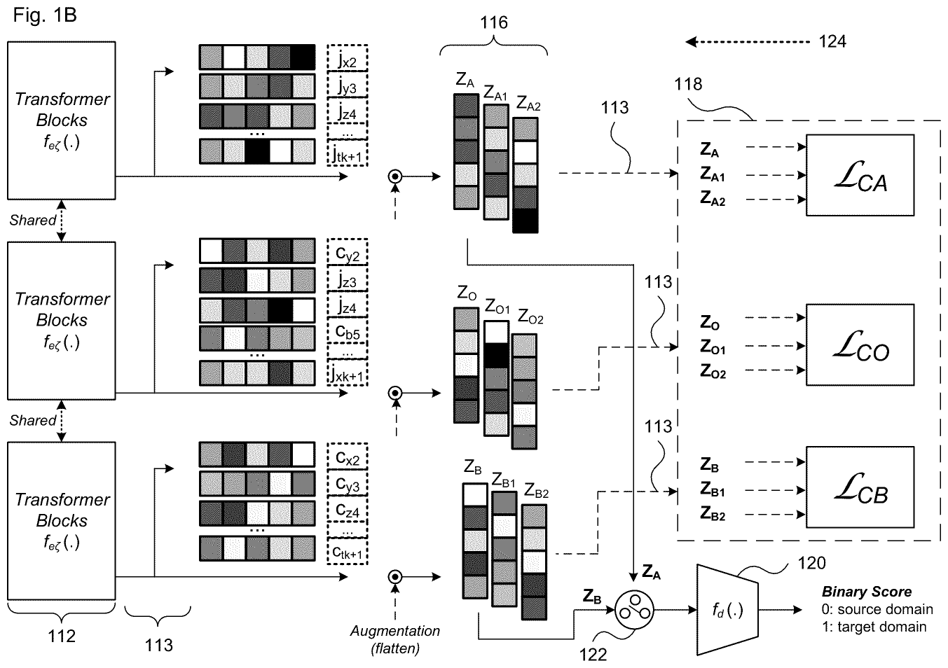

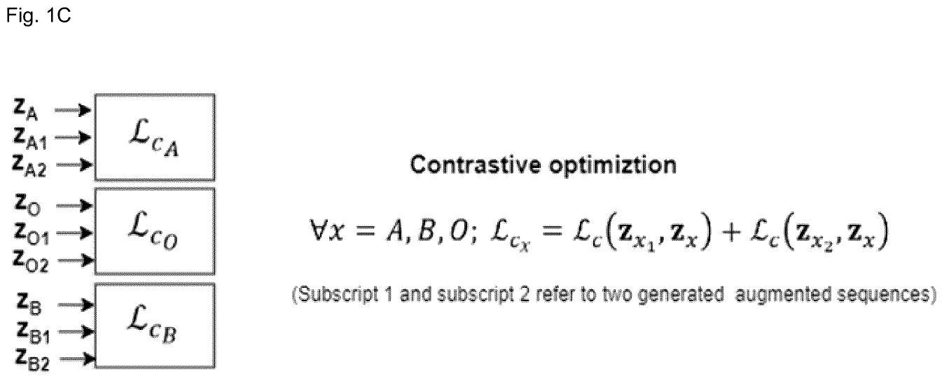

In particular, as discussed herein, a contrastive learning model for cross-domain sequence-aware recommendation tasks is employed to take the overview of user interactions in at least two domains to derive cross-domain user preference representations that can be used to make relevant recommendations in the target domain. The schema of the framework is illustrated in the example system 100 shown in FIGS. 1A-C. This includes unsupervised pre-training of transformer-based networks for user interactions in source domain and target domain. Contrastive learning is employed, in which a contrastive loss function is optimized (contrastive optimization) to maximize the pairwise similarities of the representation of augmented sequences and the representation of the original sequence versus those from two different samples. One or more augmentation strategies are employed, which can include augmented sequences for user interactions made for non-overlapped and overlapped users by using random sequence masking and reordering. By way of example, FIG. 1A illustrates the augmentation operations denoted by the cross in a circle symbol. The user interaction sequence, e.g., S_{A}, S_{O} or S_{B} in this example, is augmented twice by two augmentation strategies, such as random token deletion and/or random reordering. The processed sequences are considered as pairs of positive samples. Other samples in the batch data may be negative samples. The contrastive optimization (see FIGS. 1B-C) forces the representation of positives to get closer while the pair of negative samples pull farther apart from each other in the user behavior sequence embedding vector.

More specifically, as illustrated in FIG. 1A, the framework first utilizes a sequential attentive encoder to capture sequential signals from user interaction sequences in the source (A) domain 102 and target (B) domain 104. As shown in this example, source domain (A) includes three users, P, G and M, while target domain (B) includes three users P, M and N. Given user sequences from the source domain (A) and the target domain (B), the system first identifies any overlapped users. While only a limited number of users is shown in this example, there may be hundreds or thousands (or more) of users.

A sequential attentive encoder is assigned to capture user interactions made by overlapped users 106 in the source and target domains (here, users P and M). The sequences of user interactions in the domains and those for overlapped users are passed through the model. The model further performs adversarial training to learn the unified user representations being domain independent for each user using an adversarial objective. The system is able to optimize two single- and cross- domain next item prediction tasks under a multi-task learning paradigm, where “next value prediction” task aims to accurately predict next value of the user behavior sequence.

User interactions 108, including the interaction sequences 110 for specific users as shown, are augmented and applied to a set of transformer blocks 112 (or another neural network architecture), as shown in FIG. 1A. As illustrated in this figure by reference 114, each user interaction 108 has a corresponding taxonomy identifier at a particular time step (k). The nomenclature presented in this example uses j to denote taxonomy identifiers in the source domain and c for target domain taxonomy identifiers. The overlapped user sequences contain taxonomy identifiers from both domains.

The learning may be regulated by three components: next user interest prediction (116 in FIG. 1B), contrastive learning (118 in FIG. 1B; see also FIG. 1C), and a domain classifier (120) according to user embedding vectors that may be interleaved or otherwise input to the domain classifier as shown at 122. Back propagation is shown by dotted arrow 124. The parameters of transformer-based neural networks and the domain classifier neural network are trained. In one example, the domain classifier 120 includes a fully connected network. The contrastive loss function is optimized to maximize the pairwise similarities of the user representation based on augmented sequences and the original sequence versus those for other users. Contrastive regularization is introduced to maximize mutual information between unified representations of observed user interaction sequences and the representations of two variants generated by the suggested data augmentation strategies. The sequential recommendation model may then be fine-tuned for next value prediction on top of a pre-trained encoder optimized for user representations. FIGS. 1A-C are discussed further below.

### General Transformer Arrangement

The technology discussed herein may employ a neural network having a self-attention architecture. This may include an approach such as the Transformer architecture, described in “Attention Is All You Need”, by Vaswani et al., published on Dec. 6, 2017, which is incorporated by reference herein. Other types of machine learning architectures may alternatively be employed.

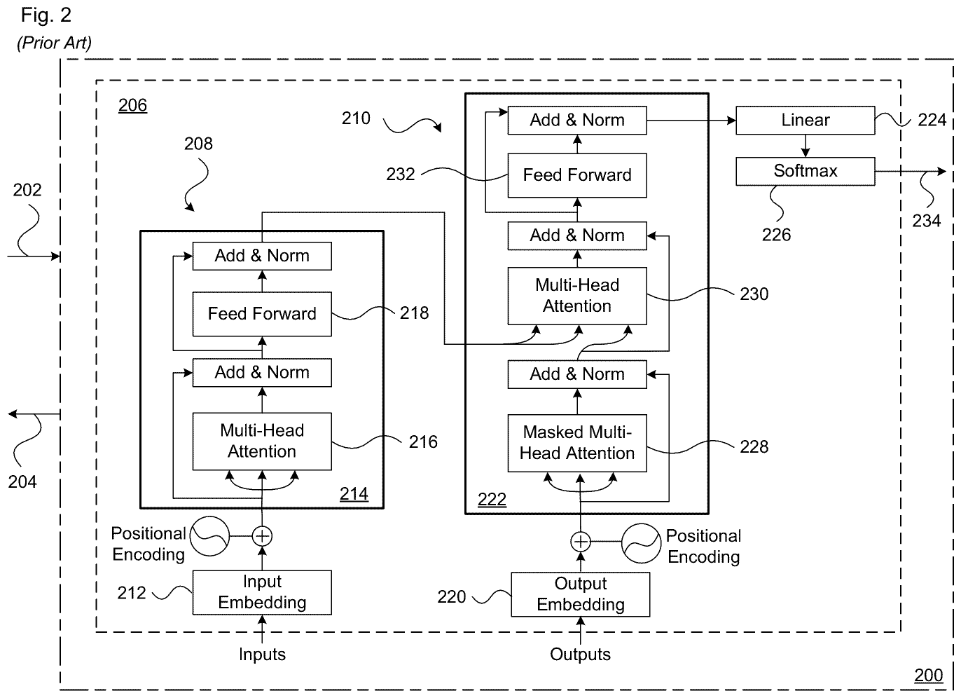

The Transformer neural network has an encoder-decoder architecture. An exemplary general Transformer-type architecture is shown in FIG. 2, which is based on the arrangement shown in U.S. Pat. No. 10,452,978, entitled “Attention-based sequence transduction neural networks”, the entire disclosure of which is incorporated herein by reference.

System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230.

Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate an updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder- decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included.

In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

According to aspects of the technology, one or more encoder neural networks 208 may be employed. Each domain's associated sequences may be embedded in parallel into a twin transformer encoder layer. This means that the encoder components share weights, enabling for a single embedding transformer to be built across two domains.

### Cross-Domain Recommendation Framework

According to aspects of the technology, a contrastive cross-domain sequential recommendation method using a neural network model. The model applies contrastive learning to improve the cross-domain sequential recommendations for predicting a user's next interest from their past sequential interactions, such as on an e-commerce platform in one scenario. The interaction may be defined as the category ID of a clicked item. In this scenario, the sequence of interacted categories is used to model the user's latent preference, defined as the concise embedding over the user's history. The inferred latent preference is subsequently used to predict the category ID associated to the next clicked item. This level of abstraction affords a less noisy view of the user's behavior and interest as it is not as granular as a single listing. The taxonomy used is hierarchical in nature. For the domains in the e-commerce problem space, one may take two root nodes in the taxonomy as the domains. Root nodes (domains) may be taken that could be tangentially related. For instance, movies and books could be viewed as tangentially related, while jewelry and food would not be viewed as being tangentially related.

Put more formally, the set of all category IDs within both domains is taken to be represented by T=t₁, t₂, . . . , t_{|T|}, with T_{A} and T_{B} being the subsets of categories in domain A and domain B, respectively. Then the system may alternate taking the domain A and the domain B as the auxiliary and target domains, so that the model can be trained across both simultaneously. The problem may be formulated as a sequence-aware recommendation task: an observed sequence of user interactions in domain B, S_{B}=((t_{y})¹, (t_{y})², . . . , (t_{y})^{|S}^{_{B}}^{|}), where t_{y} ∈ T_{B}. Information for the user can be extended by incorporating their interactions from the auxiliary domain, A, where some users interactions are taken as S_{A}=((tₓ)¹, (tₓ)², . . . , (tₓ)^{|SA|}), where tₓ ∈ T_{A}. For the overlapped users between the two domains, the cross-domain interaction sequence is denoted as S_{O}=((tₓ)¹, (t_{y})², . . . , (tₓ)ⁱ, . . . , (t_{y})^{|SO|}) as the combination of category IDs from the two domains being ordered by time.

### Next Interest Recommendation Task

The architecture employs multi-task learning over a series of tasks as follows for cross-domain recommendations, as illustrated in FIGS. 1A-C. This exemplary approach employs transformer-based encoders to take sequences from both overlapped and non-overlapped users to predict the next user interest among item categories. The encoder component 112 is composed of a stack of attention based fully connected neural layers. Each transformer layer contains self-attention nodes that accept embedding vectors including trainable embedding vectors of category IDs as well as positional embedding vectors to denote the position of the IDs in the input sequence. The trainable embedding vectors are then combined using a point-wise summation and then fed into the fully-connected neural network. The representation of user interactions is then taken as the output of last layer of the encoder component. The user representation corresponds to the last predicted time-step is considered as the embedding of the predicted next category for the user. This category embedding is considered as the network output 113 and is used as input to a loss function, as shown by dashed block 118. By way of example, the loss function may be the Bayesian personalized pairwise ranking (BPR) loss function, taking one positive sample and one negative sample as follows:

$${ℒ}_{r} = - 1 / N {\sum }_{i = 1}^{N} [ log ( σ ( {z}_{i}^{( t )} \cdot p ) ) + ( 1 - log ( σ ( {z}_{i}^{( t )} \cdot n ) ) ) ]$$

p and n are embedding vectors of the positive sample (ground-truth value) and a randomly selected negative sample, respectively. The embedding vector zᵢ^{(t)} refers to output of the encoder component in the model for time-step t. For user interactions in the source and target domain and the overlapped user sequences, one can similarly calculate BPR ranking score for the next user interest in source domain, target domain and for overlapped users.

### Adversarial Learning

Given the shared weights in the twin encoder framework of FIG. 1A, the model could generate wild representations of user interactions in two domains. To avoid this, and to learn unified user representations, adversarial regularization is adopted as the penalty term to minimize the difference between distributions of user representations in domain A and domain B. The adversarial learning component employs a domain discriminator with a binary classification functionality as shown by domain classifier 120. This component attempts to classify the source domain given a user latent representation, in other words whether the latent representation is of an input sequence belonging to domain A or domain B. More particularly, the output of the domain classifier 120 is binary value that is taken by the following objective function to update a user behavior sequence embedding vector. It is designed to obtain a unified user behavior sequence embedding vector by using the negative discrimination optimization along with contrastive objective function and given user behavior sequence from the first domain (source domain, e.g., Jewelry) of listing IDs or the first domain (target domain, e.g., Clothing) of listing IDs.

To this end, the system may use the binary cross-entropy described in the following equation:

$${ℒ}_{adv} = - \frac{1}{N} {\sum }_{i = 1}^{N} ( {y}_{i} log ( σ ( {f}_{d} ( {z}_{i} ) ) ) + ( 1 - {y}_{i} ) log ( 1 - σ ( {f}_{d} ( {z}_{i} ) ) ) )$$

where zᵢ is the representation generated by the encoder, σ is the sigmoid function and f_{d}(.) is the domain discriminator network which generates a logit value hi=f_{d}(zᵢ). y ∈ 0, 1 is the binary value which shows the target value when the domain value refers to source domain as 0 and target domain as 1.

### Contrastive Learning

According to FIG. 1A, single domain representations are learned separately from the sequences of user interactions S_{A}, S_{B} and overlapped user interactions, which capture the partial user preferences in either domains or limited overlapped users behind the sequences. A contrastive learning approach is implemented to make full use of unlabeled data on sequences via data augmentation and pair-wise training to guide better knowledge transfer for recommendations in target domain. A specific contrastive optimization is shown in FIG. 1C, where the subscripts 1 and 2 refer to two generated augmented sequences. Random masking may use deletion and reordering on input sequences to create two new variants of each input sequence. FIG. 1A shows examples of such new variants (here, S_{A1}, S_{A2}, S_{O1}, S_{O2}, S_{B1}, S_{B2}).

The contrastive loss function is defined over the combination of augmented sequences and their corresponding original sequences. The loss enforces that the pairs of augmented and original sequences are closer in the embedding spaces than any other possible pairs within the batch. Considering a batch of data, an augmented dataset may be constructed by calling the previously described augmentation strategies twice for all input sequences. For the contrastive loss, two (or more) augmented sequences from the same user interaction sequence (e.g., S_{A1}, S_{A2}, S_{O1}, S_{O2}, S_{B1}, S_{B2}) are considered as positive pair while pairwise combination of the rest of samples in the batch of are considered as negative samples. The contrastive loss function between pair of positive representations can be calculated via a Barlow-twins contrastive loss function. It functions over the cross-multiplication matrix:

C=Z¹^{^{T}}·Z²^{^{T}}∈ [symbol] ^{d×d}

where d is the dimension of hidden layer of the encoder component in the model.

### Model Optimization

Optimization for cross-domain recommendation may be formulated as a multi-task learning problem containing regularization terms and additional information from the other domains. According to one aspect of the technology, using the output from the neural network (113) optimization employs pair-wise BPR recommendation objective functions to learn latent user representations in domain A and domain B, adversarial learning with a reverse gradient layer combined with the contrastive loss function under multi-task learning paradigm. The total optimization may be done by using the linear combination of three types of loss functions with respect to three next value prediction tasks for overlapped user sequences and nonoverlapped users in two domains and the adversarial learning component and the contrastive representation estimation task as follows:

arg min ( [symbol] _{C}_{_{A}}+ [symbol] _{C}_{_{B}}+ [symbol] _{C}_{_{O}})−β [symbol] _{adv}+α( [symbol] ᵣ_{_{A}}+ [symbol] ᵣ_{_{B}}+ [symbol] ᵣ_{_{O}})θ

where ( [symbol] _{C}_{_{A}}+ [symbol] _{C}_{_{B}}+ [symbol] _{C}_{_{O}}) are the contrastive objectives, and ( [symbol] ᵣ_{_{A}}+ [symbol] ᵣ_{_{B}}+ [symbol] ᵣ_{_{O}}) are the sequential recommendation objectives.

Here, θ refers to trainable weights in encoder networks according to overlapped user interaction (denoted by subscript O) and the user interaction of non-overlapped users in the source domain A and the target domain B. The aggregated representations learned by the encoder component may be employed in a fine-tuning step for recommendation task in the target domain.

### Testing

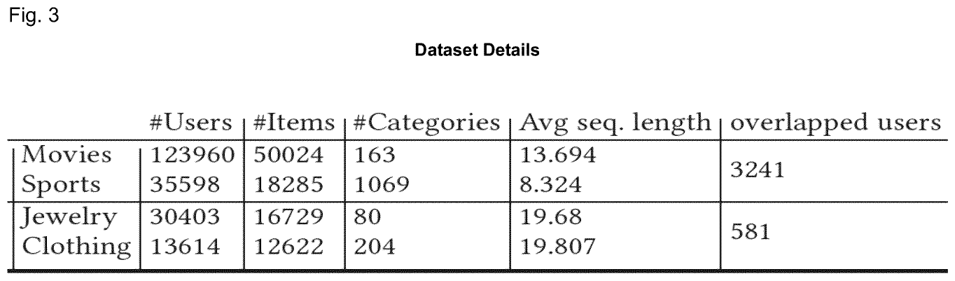

Testing was conducted on various datasets from different e-commerce platforms. FIG. 3 illustrates Table 1, which illustrate dataset details from a first e-commerce platform regarding movies and sports, and a second e-commerce platform regarding jewelry and clothing. The details include the number of users, number of items, number of different categories of items, an average sequence length (the average of the length of user behavior sequences collected from each taxonomy(domain)), and a number of overlapped users between the two types of goods or services.

In particular, the movies item encompasses both movies and television-related content and the sports item encompasses both sports and outdoors-related content from the first e-commerce platform. These relevant domains were obtained from a public product review dataset to organize two cross-domain recommendation datasets. The jewelry and clothing-related content from the second e-commerce platform is based on a data log of user interactions between June 2022 till August 2022 from that platform. A cross-domain scenario was constructed in pairs by picking “Jewelry” and “Clothing” as two largest domains in the online marketplace associated with the second e-commerce platform. As shown in Table 1, there are less than 5% overlapped users (581) between jewelry and clothing, making this dataset a sparser dataset for cross-domain recommendation task, comparing to the movies and sports dataset.

The testing used Recall and Normalized Discounted Cumulative Gain (NDCG) on top-k positions k=5, 10 as the evaluation metrics. A strategy was adopted to reduce computation cost by using random negative sampling to calculate the above rank-based scores to consider 100 random negative samples along with ground-truth taxonomy-IDs forming the set of candidates for evaluation.

The effectiveness of the above-described cross-domain recommendation via contrastive learning (CSCDR) technology was compared with following single domain recommendation methods and cross-domain recommendation baseline methods: MostPop which is a simple heuristic baseline method to recommend item taxonomies being ranked according to their popularity, NextItNet, SASRec and RecGURU. NextItNet was described by Yuan et al. in “A Simple Convolutional Generative Network for Next Item Recommendation”, published in August 2018. SASRec was described by Yuan et al. in “A Simple Convolutional Generative Network for Next Item Recommendation”, published in August 2018. And RecGURU was described by Li et al. in “RecGURU: Adversarial Learning of Generalized User Representations for Cross-Domain Recommendation”, published November 2021. Each of these references is incorporated herein by reference in their entirety.

For the sequential recommendation task, during testing preprocessing practices for sequential recommendation task as described in “A Simple Convolutional Generative Network for Next Item Recommendation” were followed to order user interactions by the timestamp to create sequences and use the most recent time-step of the sequences for test dataset, the second most recent time-step for validation and the remaining time-step in the user interaction sequences as training data. Adam optimizers, as described by Diederik P. Kingma and Jimmy Ba in “Adam: A Method for Stochastic Optimization”, published in 2014, in two stages of training to update parameters in the proposed method. The batch size in all datasets was 256. 64 was selected as the size of latent dimension in all models. A maximum length 100 was selected after a grid search on all datasets. A search grid was adopted to tune the hyperparameters including the learning rate and the trading off parameters α and β as 0.001, 1 and 0.25 respectively.

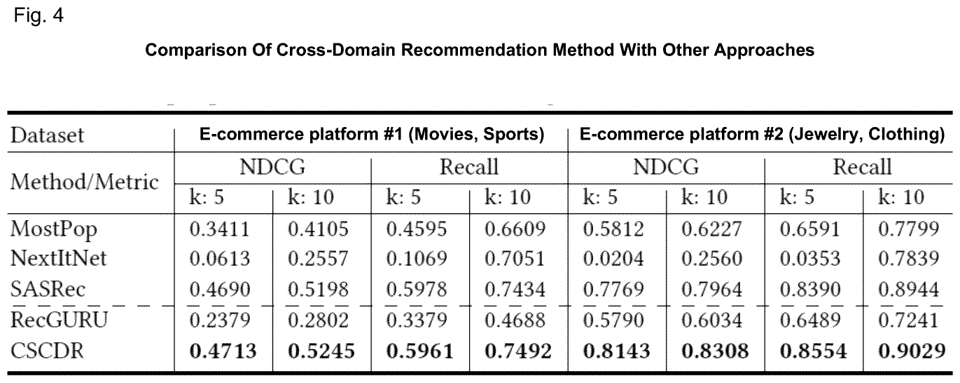

Table 2 in FIG. 4 illustrates the performance of each model mentioned above and the CSCDR model on the two different datasets of Table 1. According to the results, it can be seen that the group of the methods which use transformers in their structure for sequence modeling perform better compared to other models. For example, SasRec performed quite better than convolutional based neural network NextItNet to capture temporal correlation in sequences and predict user preferences. Comparing the cross-domain methods and the remaining single domain recommendation models, the CSCDR technology achieved the top performance against the best given by other baselines methods under all metrics.

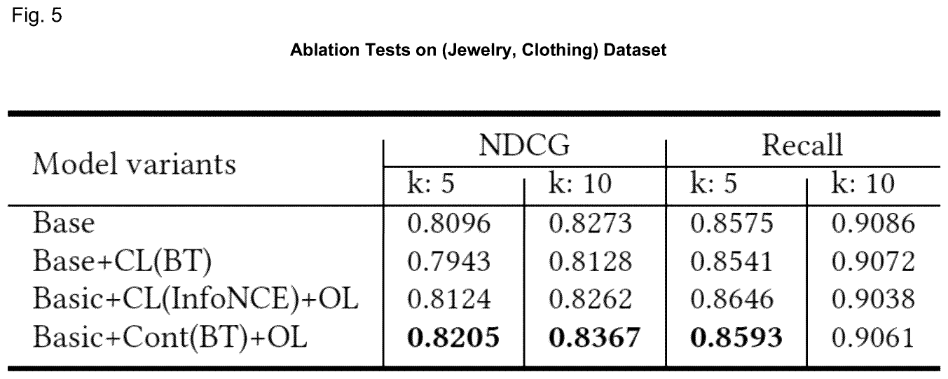

Performance of variants of the CSCDR method for the target domain recommendation task is illustrated in Table 3 of FIG. 5. In particular, Table 3 demonstrates the results of ablation tests the second e-commerce dataset (Jewelry, Clothing). Variants were created by varying the optimization from using just base cross-domain sequential recommendation by ignoring overlapped user interactions, shown as “OL” and contrastive learning sub-module as “CL” in the table. The two types of contrastive learning used for experiments are denoted by “InfoNCE” [2] and “BT”, InfoNCE is described by Chen et al. in “A Simple Framework for Contrastive Learning of Visual Representations”, published February 2020. BT is described by Zbontar et al. in “Barlow Twins: Self-Supervised Learning via Redundancy Reduction. Both of these references are incorporated herein by reference. According to the results shown in Table 3, optimizing the model to learn user representations with the combination of the sub-modules can be helpful to provide the robust representations and to improve the performance of the recommendation task.

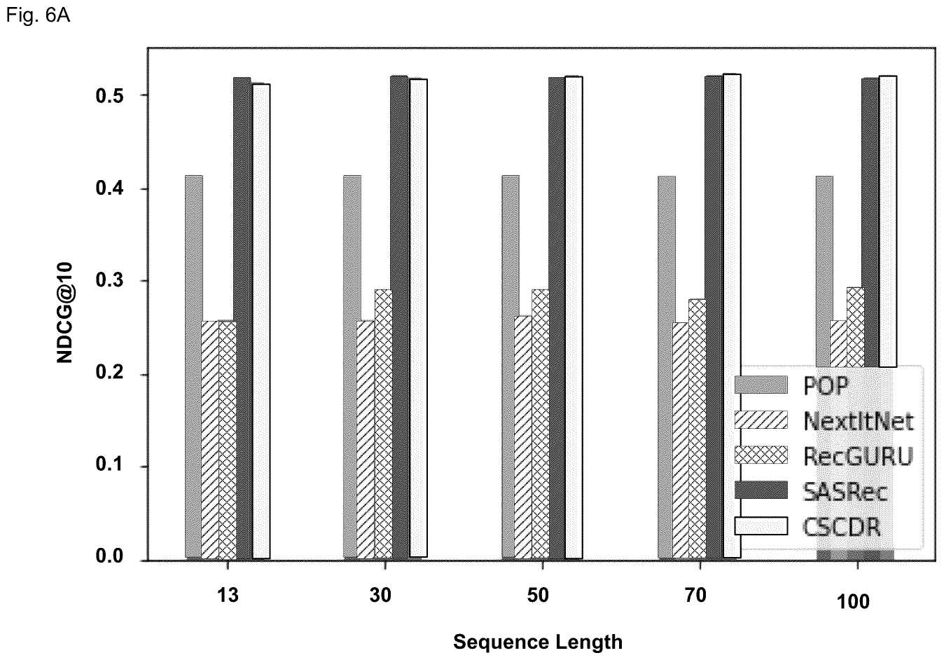

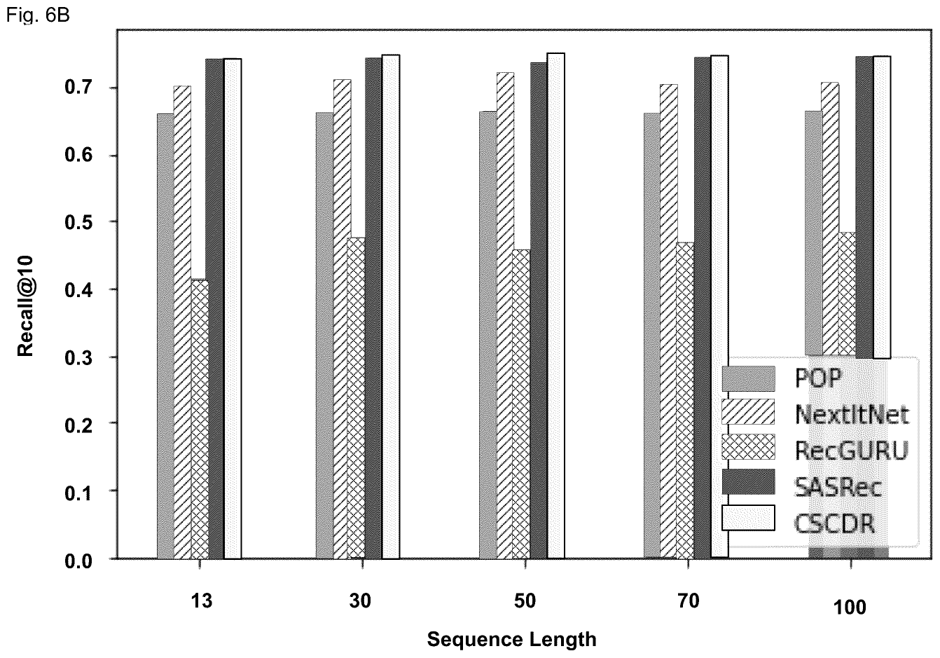

Testing also evaluated the impact of the sequence length parameter on the performance of all models on the first e-commerce dataset (Movies, Sports). In order to understand the impact of this parameter, the session length was categorized into 5 levels to cover different short, medium, and long sessions. All models were trained with different values of sequence length and evaluate the recommendation performances by using NDCG@10 and HIT@10 for evaluation. FIGS. 6A-B compare the choices of this parameter. According to the results, the CSCDR method outperforms for all bins of sequence length, with nearly equivalent test results for SASRec on short sequence length. This may be because of noise included to augmented data, which could have made it difficult to capture the pattern in short sequence lengths. Regardless, the CSCDR approach was shown to be consistently at least as effective if not substantially more effective than baseline techniques.

### Example Computing Architecture

Model training and inference may be performed on one or more tensor processing units (TPUs), CPUs or other computing architectures in order to implement the technical features disclosed herein.

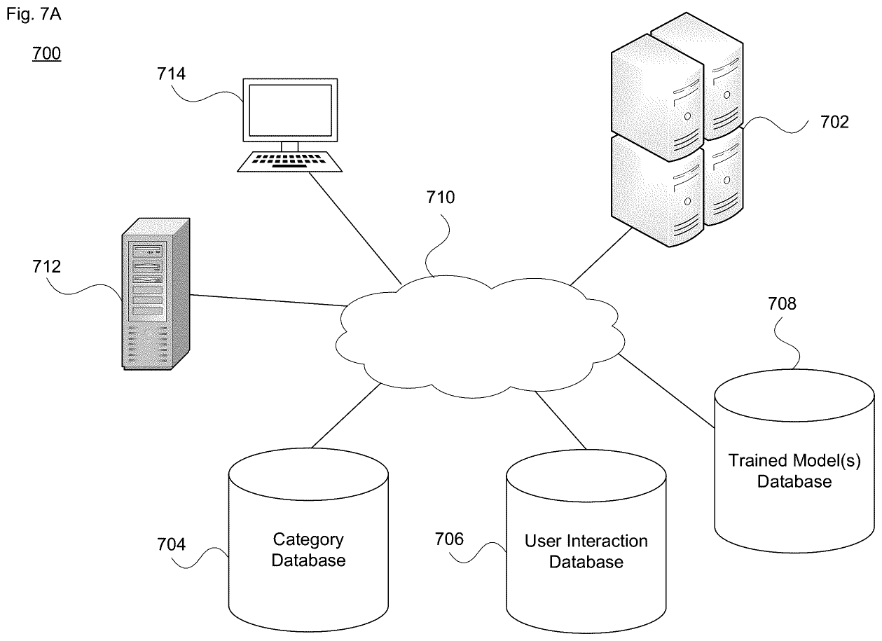

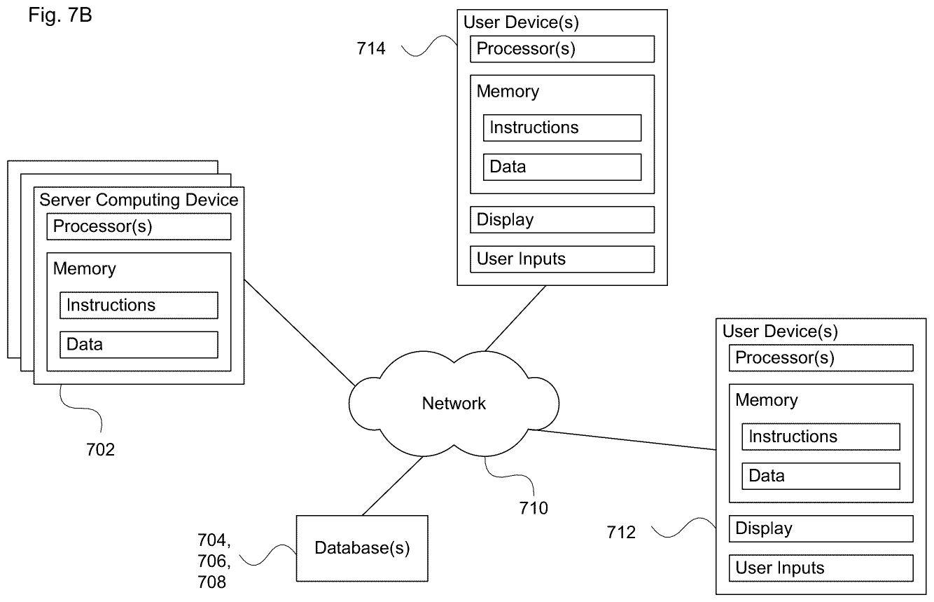

One example computing architecture is shown in FIGS. 7A and 7B. In particular, FIGS. 7A and 7B are pictorial and functional diagrams, respectively, of an example system 700 that includes a plurality of computing devices and databases connected via a network. For instance, computing device(s) 702 may be a single server farm or a cloud-based server system, which may provide or support an e-commerce system having one or more websites for various good and/or services. Databases 704, 706 and 708 may store, e.g., a corpus of goods and/or services in multiple categories (e.g., maintained in a structured taxonomy with corresponding category IDs), a corpus of user interactions (e.g., shopping for goods or services, purchases or other conversions, customer reviews, etc.) that may be associated with one or more categories, and one or more trained models as discussed herein. The server system may access the databases via network 710. One or more user devices or systems may include a computing system 712 and a desktop computer 714, for instance to train a model or to provide user interactions (e.g., browsing, clicking, purchasing and/or subscribing actions) and/or other information to the computing device(s) 702. Other types of user devices, such as mobile phones, tablet PCs, smartwatches, head-mounted displays and other wearables, etc., may also be employed.

As shown in FIG. 7B, each of the computing devices 702 and 712-714 may include one or more processors, memory, data and instructions. The memory stores information accessible by the one or more processors, including instructions and data (e.g., machine translation model, parallel corpus information, feature extractors, etc.) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media.

The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, etc. Alternatively, each processor may be a dedicated device such as an ASIC or other hardware-based processor. Although FIG. 7B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 702. Accordingly, references to a processor or computing device will be understood to include references to a collection of processors or computing devices or memories that may or may not operate in parallel.

The data, such as category and/or user interaction information, may be operated on by the system to train one or more models. This can include augmenting certain information from the datasets. The trained models may be used to provide product or service recommendations to one or more users, for instance users of computers 712 and/or 714.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 712-714) may communicate with a back-end computing system (e.g., server 702) via one or more networks, such as network 710. The network 710, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 702 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 702 may include one or more server computing devices that are capable of communicating with any of the computing devices 712-714 via the network 710.

### Exemplary Method of Operation

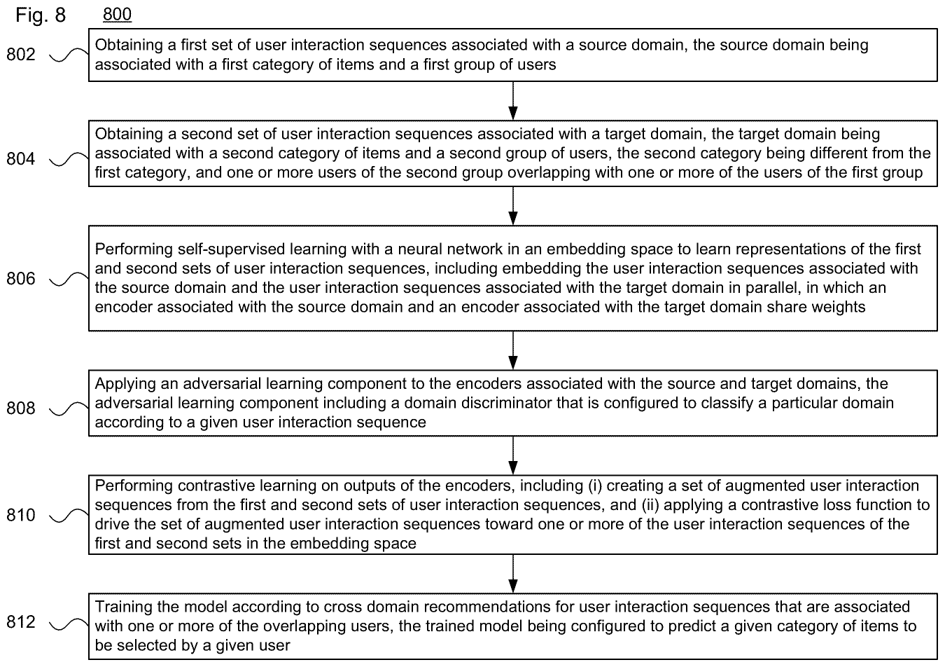

FIG. 8 illustrates a computer-implemented method 800 for training a model for cross-domain recommendations. At block 802, the method includes obtaining a first set of user interaction sequences associated with a source domain. The source domain is. associated with a first category of items and a first group of users. At block 804, the method also includes obtaining a second set of user interaction sequences associated with a target domain. The target domain is associated with a second category of items and a second group of users, in which the second category is different from the first category, and one or more users of the second group overlap with one or more of the users of the first group. At block 806, the method includes performing self-supervised learning with a neural network in an embedding space to learn representations of the first and second sets of user interaction sequences. This includes embedding the user interaction sequences associated with the source domain and the user interaction sequences associated with the target domain in parallel, in which an encoder associated with the source domain and an encoder associated with the target domain share weights. At block 808, the method includes applying an adversarial learning component to the encoders associated with the source and target domains. The adversarial learning component includes a domain discriminator that is configured to classify a particular domain according to a given user interaction sequence. At block 810, the method includes performing contrastive learning on outputs of the encoders, including (i) creating a set of augmented user interaction sequences from the first and second sets of user interaction sequences, and (ii) applying a contrastive loss function to drive the set of augmented user interaction sequences toward one or more of the user interaction sequences of the first and second sets in the embedding space. And at block 812, the method includes training the model according to cross domain recommendations for user interaction sequences that are associated with one or more of the overlapping users, where the trained model is configured to predict a given category of items to be selected by a given user.

By way of example only, the trained model may be used in the following manner: first receiving, by a processing device of an e-commerce website, user input. Then identifying, by the processing device according to the trained model, one or more items of interest. The system may then generate information about the one or more items of interest, and cause the generated information to be presented to a selected user.

Unless expressly stated otherwise, the foregoing examples and arrangements are not mutually exclusive and may be implemented in various ways to achieve unique advantages. These and other variations and combinations of the features discussed herein can be employed without departing from the subject matter defined by the claims. In view of this, the foregoing description of exemplary embodiments should be taken by way of illustration rather than by way of limitation.

The examples described herein, as well as clauses phrased as “such as,” “including” and the like, should not be interpreted as limiting the subject matter of the claims to any specific examples. Rather, such examples are intended to illustrate possible embodiments. Further, the same reference numbers in different drawings can identify the same or similar elements. The processes or other operations may be performed in a different order or concurrently, unless expressly indicated otherwise herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. As used in this document, “each” refers to each member of a set or each member of a subset of a set.

To aid the Patent Office and any readers of any patent issued on this application in interpreting the claims appended hereto, Applicant notes that it does not intend any of the appended claims or claim elements to invoke 35 U.S.C. 112(f) unless the words “means for” or “step for” are explicitly used in the particular claim.

1. A computer-implemented method for training a model for cross-domain recommendations, the method comprising:
obtaining a first set of user interaction sequences associated with a source domain, the source domain being associated with a first category of items and a first group of users;
obtaining a second set of user interaction sequences associated with a target domain, the target domain being associated with a second category of items and a second group of users, the second category being different from the first category, and one or more users of the second group overlapping with one or more of the users of the first group;
performing self-supervised learning with a neural network in an embedding space to learn representations of the first and second sets of user interaction sequences, including embedding the user interaction sequences associated with the source domain and the user interaction sequences associated with the target domain in parallel, in which an encoder associated with the source domain and an encoder associated with the target domain share weights;
applying an adversarial learning component to the encoders associated with the source and target domains, the adversarial learning component including a domain discriminator that is configured to classify a particular domain according to a given user interaction sequence;
performing contrastive learning on outputs of the encoders, including (i) creating a set of augmented user interaction sequences from the first and second sets of user interaction sequences, and (ii) applying a contrastive loss function to drive the set of augmented user interaction sequences toward one or more of the user interaction sequences of the first and second sets in the embedding space; and
training the model according to cross domain recommendations for user interaction sequences that are associated with one or more of the overlapping users, the trained model being configured to predict a given category of items to be selected by a given user.

2. The method of claim 1, further comprising:
receiving, by a processing device, user input regarding an item;
identifying, by the processing device according to the trained model, one or more items of the given category of items; and
causing, by the processing device, the one or more identified items to be presented to the given user.

3. The method of claim 1, further comprising reordering at least one of the first set of user interaction sequences or the second set of user interaction sequences.

4. The method of claim 3, wherein the reordering comprises:
generating a binary mask vector of either the first set of user interaction sequences or the second set of user interaction sequences; and
applying a random shuffling to reorder one or more non-zero values in the binary vector.

5. The method of claim 1, further comprising creating a nominal overlapping user based upon a first user that only has interaction sequences in the source domain and a second user that has interaction sequences in both the source domain and the target domain.

6. The method of claim 5, wherein the second user's interaction sequences in the source domain correlates with the first user's interaction sequences in the source domain.

7. The method of claim 1, wherein embedding the user interaction sequences associated with the source domain and the user interaction sequences associated with the target domain in parallel comprises embedding into a twin transformer encoder layer of an encoder component of the neural network.

8. The method of claim 1, wherein the method includes the domain discriminator performing binary classification according to a user latent representation.

9. The method of claim 8, wherein the binary classification produces a unified user behavior sequence embedding vector.

10. A method, comprising:
receiving, by a processing device of an e-commerce web site, user input;
identifying, by the processing device according to the model of claim 1, one or more items of interest;
generating information about the one or more items of interest; and
causing the generated information to be presented to a selected user.

11. The method of claim 10, wherein:
the first category of items and the second category of items used to train the model are goods offered by the e-commerce web site; and
causing the generated information to be presented to the selected user includes generating information about selected goods from a category of items promoted by the e-commerce website.

12. The method of claim 10, wherein prior user interaction sequences by the selected user are only associated with one of the source domain or the target domain.

13. A computer system configured to train a model for cross-domain recommendations, the computer system comprising:
memory configured to store input source audio comprising one or more longform speech documents that are at least a minute in length; and
one or more processors operatively coupled to the memory, the one or more processors being configured to implement a neural network that:
obtains a first set of user interaction sequences associated with a source domain, the source domain being associated with a first category of items and a first group of users;
obtains a second set of user interaction sequences associated with a target domain, the target domain being associated with a second category of items and a second group of users, the second category being different from the first category, and one or more users of the second group overlapping with one or more of the users of the first group;
performs self-supervised learning with a neural network in an embedding space to learn representations of the first and second sets of user interaction sequences, including embedding the user interaction sequences associated with the source domain and the user interaction sequences associated with the target domain, in which an encoder associated with the source domain and an encoder associated with the target domain share weights;
applies an adversarial learning component to the encoders associated with the source and target domains, the adversarial learning component including a domain discriminator that is configured to classify a particular domain according to a given user interaction sequence;
performs contrastive learning on outputs of the encoders, including (i) creating a set of augmented user interaction sequences from the first and second sets of user interaction sequences, and (ii) applying a contrastive loss function to drive the set of augmented user interaction sequences toward one or more of the user interaction sequences of the first and second sets in the embedding space; and
trains the model according to cross domain recommendations for user interaction sequences that are associated with one or more of the overlapping users, the trained model being configured to predict a given category of items to be selected by a given user.

14. The computer system of claim 13, wherein the neural network has a transformer architecture.

15. The computer system of claim 13, wherein the encoders are attention-based encoders.

16. The computer system of claim 13, wherein the computer system is further configured to:
receive user input regarding an item;
identify, according to the trained model, one or more items of the given category of items; and
cause the one or more identified items to be presented to the given user.

17. The computer system of claim 13, wherein embedding the user interaction sequences associated with the source domain and the user interaction sequences associated with the target domain in parallel comprises embedding into a twin transformer encoder layer of an encoder component of the neural network.

18. The computer system of claim 13, wherein the domain discriminator is configured to perform binary classification according to a user latent representation.

19. The computer system of claim 18, wherein the binary classification produces a unified user behavior sequence embedding vector.

20. The computer system of claim 13, wherein the domain discriminator includes a fully connected network.
